(19) United States
(12) Patent Application Publication
(10) Pub. No.: US 2010/0290621 A1
(43) Pub. Date: Nov. 18, 2010

(54) TUNNELING SUPPORT FOR MOBILE IP USING A KEY FOR FLOW IDENTIFICATION

(75) Inventors: Ahmad Muhanna, Richardson, TX (US); Mohamed Khalil, Murphy, TX (US); Barnaba Barnowski, Calgary, CA (CA); Curtis Provost, Parker, TX (US)

Correspondence Address: TROP, PRUNER & HU, P.C., 1616 S. VOSS ROAD, SUITE 750, HOUSTON, TX, 77057-2631, US

(73) Assignee: NORTEL NETWORKS LIMITED, ST. LAURENT, QE (CA)

(21) Appl. No.: 12/530,905

(22) PCT Filed: Mar. 12, 2008
(86) PCT No.: PCT/US08/56629

§ 371 Date: Sep. 11, 2009

Related U.S. Application Data
(60) Provisional application No. 60/894,394, filed on Mar. 12, 2007.
(60) Provisional application No. 60/917,695, filed on May 14, 2007.

(51) Int. Cl. H04L 9/00; H04W 4/00; H04W 36/16

(52) U.S. Cl. 380/270; 370/329; 370/331

(57) ABSTRACT

In a network that supports mobility of a mobile node, a tunnel between a first mobility node and a second mobility node is established in the network. The established tunnel is according to a tunneling protocol (e.g., Generic Routing Encapsulation tunneling protocol) that uses at least one key (208) for encapsulating data communicated through the tunnel. The symmetric or asymmetric key may be used for identifying a particular traffic flow in either the forward or the reverse direction between mobility nodes, e.g., when supporting mobility nodes that are using overlapping private IPv4 addressing. Signaling is communicated to provide mobility support of the mobile node according to a mobility protocol, where the mobility protocol is selected from among a Proxy Mobile Internet Protocol and Mobile IP version 6.

### TECHNICAL FIELD

The invention relates generally to providing tunneling support for mobile Internet Protocol communications.

### BACKGROUND

Networks are used to link various types of network elements, such as personal computers, mobile telephones, Internet appliances, personal digital assistants (PDAs), and so forth. Mobility of network elements is a desired feature. As a user travels between different points, the point of attachment of the network element associated with a user may change. To provide enhanced flexibility and convenience in allowing a user to change points of attachment across different networks, Mobile IP (Internet Protocol) was defined. The versions of Mobile IP include Mobile IPv4 and Mobile IPv6.

Generally, according to Mobile IPv6, mobility is managed by a mobile node. More recently, Proxy Mobile IPv4 and IPv6 have been proposed to provide network-based mobility. According to Proxy Mobile IP (IPv4 or IPv6), the mobile node does not have to be involved in the exchange of signaling messaging for mobility management on behalf of the mobile node.

The base Proxy Mobile IP protocol assumes that only IP-in-IP encapsulation is used for tunneling bearer data between nodes in the Proxy Mobile IP network. In the Proxy Mobile IPv6 context, such nodes include a mobile access gateway (MAG) and a local mobility anchor (LMA). The MAG manages the mobility-related signaling for a mobile node that is attached to the MAG. The LMA provides the functionalities of a home agent, as well as other functionalities to support the Proxy Mobile IPv6 protocol.

An issue associated with using IP-in-IP tunneling is that such tunneling cannot be used if the packets in the inner tunnel have overlapping private IP addresses. For example, mobile nodes associated with different network operators or service providers may be assigned the same private IP address in their respective networks. Such overlapping of private IP addresses would prevent the correct use of IP-in-IP tunneling. Also, flexibility associated with IP-in-IP tunneling is relatively limited.

### SUMMARY OF THE INVENTION

In general, according to an embodiment, a tunnel is established between a first mobility node and a second mobility node of a network that supports mobility of a mobile node. The established tunnel is according to a tunneling protocol that uses at least one key for encapsulating data communicated through the tunnel. Signaling according to a mobility protocol is communicated to provide mobility support of the mobile node. The mobility protocol is selected from among a Proxy Mobile Internet Protocol (IP) and Mobile Internet Protocol version 6 (IPv6).

Other or alternative features will become apparent from the following description, from the drawings, and from the claims.

### BRIEF DESCRIPTION OF THE DRAWINGS

FIG. 1 is a block diagram of an example arrangement of a mobility network in which a preferred embodiment of the invention can be incorporated.

FIGS. 2 and 3 illustrate example formats of a Generic Routing Encapsulation (GRE) key option and GRE header, respectively, in accordance with preferred embodiments.

FIGS. 4 and 5 are flow diagrams of operations of mobility nodes to support GRE tunneling according to preferred embodiments.

FIG. 6 is a message flow diagram illustrating a procedure according to another preferred embodiment.

### DETAILED DESCRIPTION OF PREFERRED EMBODIMENTS OF THE INVENTION

In the following description, numerous details are set forth to provide an understanding of some embodiments. However, it will be understood by those skilled in the art that some embodiments may be practiced without these details and that numerous variations or modifications from the described embodiments may be possible.

In accordance with preferred embodiments, a technique or mechanism is provided to enable a first mobility node in a mobility network to provide an indication to a peer mobility node that a tunnel is to be established between the mobility nodes. The particular tunnel to be established, in accordance with a preferred embodiment, is a Generic Routing Encapsulation (GRE) tunnel. GRE is a tunneling protocol for encapsulating a variety of network layer packets inside Internet Protocol (IP) packets. A version of GRE is described in Request for Comments (RFC) 2784, entitled “Generic Routing Encapsulation (GRE),” dated March 2000. A GRE encapsulated packet typically includes the following: a delivery IP header, a GRE header, and a payload packet (which contains the underlying IP packet). The GRE protocol supports the use of a key (referred to as a “GRE key”) that can be provided in the GRE header, where the key is used for identifying a particular traffic flow in either the forward or reverse direction between mobility nodes. A traffic flow refers to communication of either user or control traffic in a session or other exchange.

A mobility network is a network in which a mobile node (e.g., portable computer, personal digital assistant or PDA, mobile telephone, etc.) can be physically moved between different locations. As the mobile node is moved between different locations, the mobile node is attached to different access points. In some preferred embodiments, mobility is defined by Internet Protocol (IP) mobility, such as Mobile IPv6. A current version of Mobile IPv6 is defined in RFC 3775, entitled “Mobility Support in IPv6,” dated June 2004. Alternatively, mobility can be provided by a Proxy Mobile IP Protocol, such as Proxy Mobile IPv4 or Proxy Mobile IPv6. A current version of Proxy Mobile IPv6 is described in Internet-Draft, entitled “Proxy Mobile IPv6,” draft-ietf-netlmm-proxymip6-11.txt, dated Feb. 25, 2008. A current version of Proxy Mobile IPv4 is described in Internet-Draft, entitled “WiMAX Forum/3GPP2 Proxy Mobile IPv4,” draft-leung-mip4-proxy-mode-07.txt, dated Feb. 13, 2008.

In other preferred embodiments, other tunneling protocols that use keys for encapsulating data in traffic flows can be employed instead of the GRE protocol. In the ensuing discussion, reference is made to use of the GRE tunneling protocol between mobility nodes in a mobility network. Note that similar techniques can also be applied for other tunneling protocols that use keys for encapsulating data in traffic flows.

The use of GRE in communications within a mobility network may provide one or more of the following benefits. Flexibility is enhanced by defining one or multiple tunnels for each mobile station, in both the reverse and forward directions (the forward direction refers to the direction of traffic flow from the network to the mobile node, and the reverse direction of traffic flow from the mobile node to the network). By using GRE tunnels, the issue of overlapping private IP addresses assigned to multiple mobile stations by different network operators or service providers can be addressed. By using GRE keys assigned during establishment of GRE tunnels, mobility nodes in the network are able to identify traffic flows even if multiple mobile nodes are assigned the same private IP address.

Also, sequence numbers associated with the GRE tunneling protocol can be used to avoid out-of-sequence packets. This may be beneficial in applications that are sensitive to packets being out of order. Also, by being able to define multiple tunnels for a particular mobile station, different quality-of-service (QoS) levels can be provided for different IP sessions associated with different applications of the particular mobile station.

Also, in accordance with some preferred embodiments, the GRE keys for identifying the forward and reverse data paths can be symmetric GRE keys or asymmetric GRE keys. Assignment of a symmetric GRE key means that the same GRE key is used for identifying traffic flows in both the forward and reverse directions in the GRE tunnel. On the other hand, assignment of asymmetric GRE keys means that different GRE keys are used for the respective forward and reverse directions. Also, alternatively, uni-directional keys can be generated instead, where a first mobility node creates a key to be used by a second mobility node, or vice versa.

In accordance with preferred embodiments, a first mobility node is able to set an indication in a message exchanged with a peer mobility node to indicate that the peer mobility node is to establish a GRE tunnel between the first mobility node and peer mobility node for communication of bearer data traffic for a specified traffic flow in the GRE tunnel. When this indication is provided, the first mobility node also includes a GRE key option with the appropriate key information in a message sent to the peer mobility node. The GRE key option can be an extension of an existing message defined for exchange between the mobility nodes.

The indication can be explicit, and can be in the form of a flag (e.g., GRE flag) set to a particular value, or another field (e.g., home network prefix or HNP option) set to a particular value. A home network prefix (HNP) is normally used by a mobile node to construct an IP address of the mobile node. The GRE flag or HNP option can also be extensions of an existing message defined for exchange between mobility nodes.

Alternatively, the indication to establish a GRE tunnel can be implicit. For example, inclusion of a GRE key option in a message sent from the first mobility node to a peer mobility node is an implicit indication that establishment of GRE tunneling is desired, even if the GRE flag or HNP option is not set to a respective particular value as discussed above.

Also, the indication of whether a symmetric key or asymmetric keys is (are) to be created can be explicit or implicit. Explicit indication of symmetric key generation versus asymmetric key generation can be specified by selectively setting, to one of plural possible values, a particular field (described later as an Option Subtype field) in a GRE key option included in a message sent between mobility nodes. For example, a first value of the Option Subtype field indicates that asymmetric keys are to be created, whereas a second value of the Option Subtype field indicates that a symmetric key is to be generated.

An implicit indication of symmetric versus asymmetric key generation can be accomplished by setting (or not setting) a GRE key field in a GRE key option carried in a message between mobility nodes to a particular invalid value (e.g., all zeros). Setting the GRE key field to an invalid value is an implicit indication that symmetric key generation is desired. Setting the GRE key field to a valid value is an implicit indication that asymmetric key generation is desired.

As will be explained in further detail below, the messages exchanged between mobility nodes in which the above mentioned GRE key option, and/or HNP option, and or GRE flag can be carried include proxy binding update (PBU) and proxy binding acknowledgment (PBA) messages (in the Proxy Mobile IP context) or other types of messages (e.g., binding update and binding acknowledgment messages in the Mobile IPv6 context). The GRE key option, and/or HNP option, and/or GRE key flag are considered extensions of such messages. Alternatively, instead of sending a PBU message, another type of message could be used, such as a proxy registration request (RRQ) message.

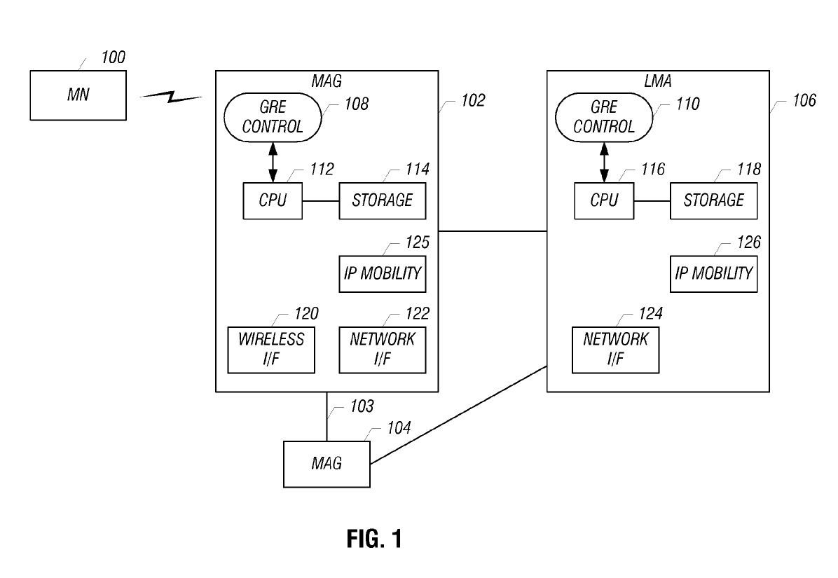

FIG. 1 illustrates an example mobility network arrangement, which according to a preferred embodiment is a Proxy Mobile IPv6 network arrangement. As depicted in FIG. 1, a mobile node 100 is able to communicate wirelessly with a mobile access gateway (MAG) 102. An MAG manages the mobility-related signaling for a mobile node that is attached to the MAG 102. The MAG can be part of an access point that communicates wirelessly with the mobile node, for example. The MAG performs mobility management on behalf of the mobile node, and also tracks the mobile node's movements so that handover between the MAG and another MAG can be performed when the mobile node crosses between coverage areas of respective MAGs. FIG. 1 also depicts another MAG 104.

The MAGs 102, 104 are connected to a local mobility anchor (LMA) 106, which provides functionalities of a home agent, as well as additional capabilities for supporting the Proxy Mobile IPv6 protocol. A home agent is able to maintain a binding for the mobile node, where a binding is the association of a home address of the mobile node (in the mobile node's home network) with a care-of address for the mobile node, along with the remaining lifetime of that association. A care-of address is the address associated with the mobile node while visiting a visited network. A home agent is a router on a mobile node's home network with which the mobile node has registered its current care-of address.

In the Proxy Mobile IPv6 context, the MAG 102 or 104 and LMA 106 are the mobility nodes between which GRE tunnels can be established according to a preferred embodiment. The endpoints of the GRE tunnel are the MAG and LMA IP addresses. Traffic communicated between the MAG and LMA is tunneled using the IP addresses of the MAG and LMA, but with the GRE key identifying the traffic flow.

Alternatively, in the Proxy Mobile IPv4 context, the mobility node 106 would be an access gateway (AGW), and the mobility nodes 102, 104 would be proxy mobility agents (PMAs). A GRE tunnel can be established between a PMA and AGW according to a preferred embodiment.

In a Mobile IPv6 context, the MAG 102 or 104 is not provided; rather, the mobile node 100 connects (e.g., wirelessly) to an access point that in turn is connected to a home agent. Thus, in the Mobile IPv6 context, the MAG 102 or 104 is replaced with an access point, and the LMA 106 is replaced with a home agent. Also, in the Mobile IPv6 context, a GRE tunnel can be established between the mobile node 100 through the access point to the home agent. In this context, the mobility nodes between which a GRE tunnel can be established are the mobile node and the home agent.

FIG. 1 also depicts a link 103 between the MAGs 102 and 104. During a handover procedure, such as when the mobile node 100 is being handed off from the MAG 102 to the MAG 104, a GRE tunnel can be established between the MAGs 102 and 104 over the link 103 according to a preferred embodiment.

The ensuing discussion describes establishing a GRE tunnel between a MAG and an LMA. Note that similar techniques can also be applied to establish a tunnel between two MAGs, between a PMA and a AGW (Proxy Mobile IPv4), and between a mobile node and a home agent (Mobile IPv6).

The MAG can set an explicit indication (e.g., GRE flag or HNP option) to a predefined value to indicate to the LMA 106 that the LMA should use the GRE tunneling mechanism for bearer data in a traffic flow with the mobile node 100. In preferred embodiments, the indication is contained in a proxy binding update (PBU) message that is sent to the LMA 106 to update the mobile node's location and new care-of address. In alternative embodiments, the indication can be contained in other types of messages exchanged between the MAG 102, 104, and LMA 106.

To enable the establishment of a GRE tunnel between the MAG 102, 104, and the LMA 106, each of the MAG 102, 104, and LMA 106 includes a respective GRE control module 108 and 110. The GRE control module 108 or 110 can be implemented in software. Alternatively, the GRE control module can be implemented in hardware.

If implemented in software, the GRE control module 108 is executable on a central processing unit (CPU) 112, which is connected to storage 114 in the MAG 102. Similarly, the GRE control module 110 can be executable on a CPU 116 that is connected to a storage 118.

The MAG 102 also includes a wireless interface 120 to communicate wirelessly (e.g., using radio frequency communications) with the mobile node 100. The MAG 102 also includes a network interface 122 to communicate with a corresponding network interface 124 of the LMA 106. Each of the MAG 102, 104, and LMA 106 also includes a respective IP mobility module 125 or 126 to support IP mobility, such as Proxy Mobile IPv4 or Proxy Mobile IPv6. The IP mobility modules 125 and 126 are able to exchange signaling to support mobility of the mobile node 100 in the network. Note that in the Mobile IPv6 context, the IP mobility modules 125 and 126 would be included in the mobile node 100 and home agent, respectively.

An explicit indication to indicate establishment of a GRE tunnel, in accordance with some preferred embodiments, can be set by the GRE control module 108 or 110 in a message exchanged between the MAG 102, 104 and LMA 106. As noted above, one such message is the PBU message. In one example, the PBU message can include a GRE key flag that can be set to a particular value (e.g., “1”) to explicitly indicate to the LMA 106 that establishment of a GRE tunnel is desirable. Alternatively, instead of using the GRE key flag in the PBU message, an HNP option in the PBU can instead be set to a particular value (e.g., all “1s” or some other predefined value) to explicitly indicate that establishment of a GRE tunnel is desired. In yet another example, an implicit indication of the desire to establish a GRE tunnel can be provided, which can be accomplished by including a GRE key option without the GRE key flag or HNP option in the PBU message.

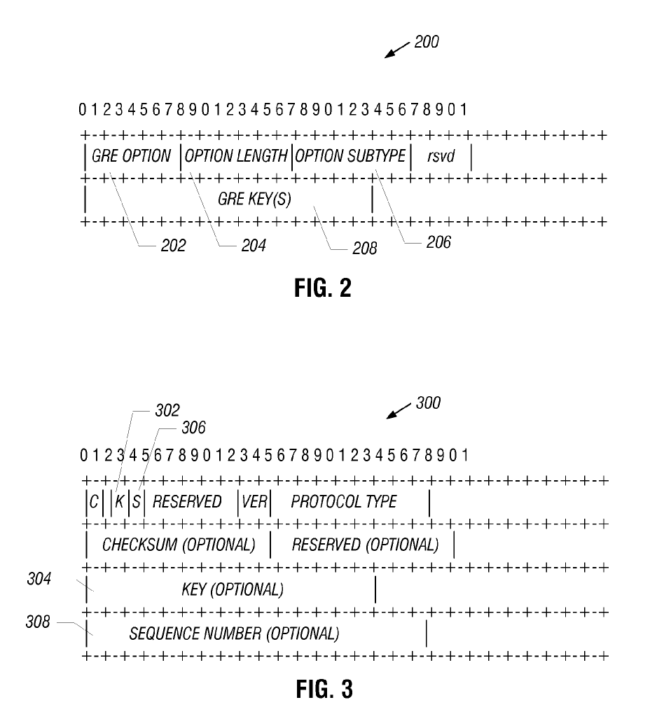

FIG. 2 shows an example GRE key option 200, which includes a GRE option field 202 (to identify the GRE key option 200 as relating to GRE), an Option Length field 204 (to indicate the length of a GRE key field 208), an Option Subtype field 206 (to indicate the type of GRE key included in the GRE key field 208). If the Option Subtype field 206 contains a first value (e.g., 01), then the key for the forward direction is included. If the Option Subtype field 206 contains a second value (e.g., 10), then the key for the reverse direction is included in the GRE field 208. If the Option Subtype field 206 contains a third value (e.g., 11), then a symmetric key that is used for both the forward and reverse directions is included. Note that different keys can be set for the forward and reverse directions using Option Subtype values of 01 or 10 to establish asymmetric keys for the forward and reverse directions.

A PBU message that contains a specified value for the Option Subtype field 206 effectively provides an explicit indication of whether asymmetric key generation or symmetric key generation is desired. A value of “01” in the Option Subtype field 206 of a PBU message is a request for asymmetric key generation, whereas a value of “11” in the Option Subtype field 206 of a PBU message is a request for symmetric key generation.

Instead of using an Option Subtype field 206 to explicitly specify creation of asymmetric versus symmetric GRE keys, an alternative technique is to use an implicit indication. This implicit indication can involve the inclusion of a predefined invalid value in the GRE key field 208 of the GRE key option (without using the Option Subtype field 206). For example, including a GRE key value of all zeros in the GRE key field 208 contained in a PBU message would be an implicit indication that a symmetric key is to be created by the LMA. A valid value of a GRE key (which would be a forward GRE key) in the GRE key field 208 contained in a PBU message would be an indication that asymmetric keys are to be used.

Once GRE keys (either asymmetric keys or a symmetric key) are negotiated, all subsequent data exchanged between the MAG and LMA for the particular traffic flow of the particular mobile node would be encapsulated using a GRE header that contains the negotiated key(s).

The format of a GRE header 300, as defined by RFC 2890, entitled “Key and Sequence Number Extensions to GRE,” dated September 2000, is depicted in FIG. 3. A Key Present bit 302 (represented as “K”) can be set to the value “1” to indicate that an optional Key field 304 is present in the GRE header 300. If the Key Present bit 302 is not set to the value “1,” then the Key field 304 is not present in the GRE header 300. The Key field 304 contains either the reverse or forward (or symmetric) GRE key negotiated between the MAG and LMA.

Another flag that is present in the GRE header is a Sequence Number Present bit (S bit) 306 that can be set to a value “1” to indicate that a Sequence Number field 308 is present.

The Key field 304 contains a GRE key for identifying an individual traffic flow within a GRE tunnel. Packets belonging to the traffic flow are encapsulated using the key value in the Key field 304, and the decapsulating tunnel endpoint identifies packets belonging to a traffic flow based on the Key field 304 value.

The Sequence Number field 308 provides a sequence number to allow the receiving endpoint to establish an order of packets sent from the encapsulator. Sequence numbers provided by Sequence Number fields 308 of packets enable in-order delivery of the packets.

The LMA 106 sends a proxy binding acknowledgment (PBA) message to the MAG 102 in response to the PBU message sent by the MAG 102. The PBA message can also contain a GRE flag to indicate to the MAG that the LMA supports and accepts GRE tunneling for the bearer data of the specified traffic flow. The GRE flag in the PBA is set only if the corresponding GRE flag in the PBU message has been set. If the GRE flag bit is set in the PBA, the LMA includes the GRE key option 200 in the PBA message.

Alternatively, the PBA message does not have to include a GRE flag, but rather, can just include the GRE key option 200.

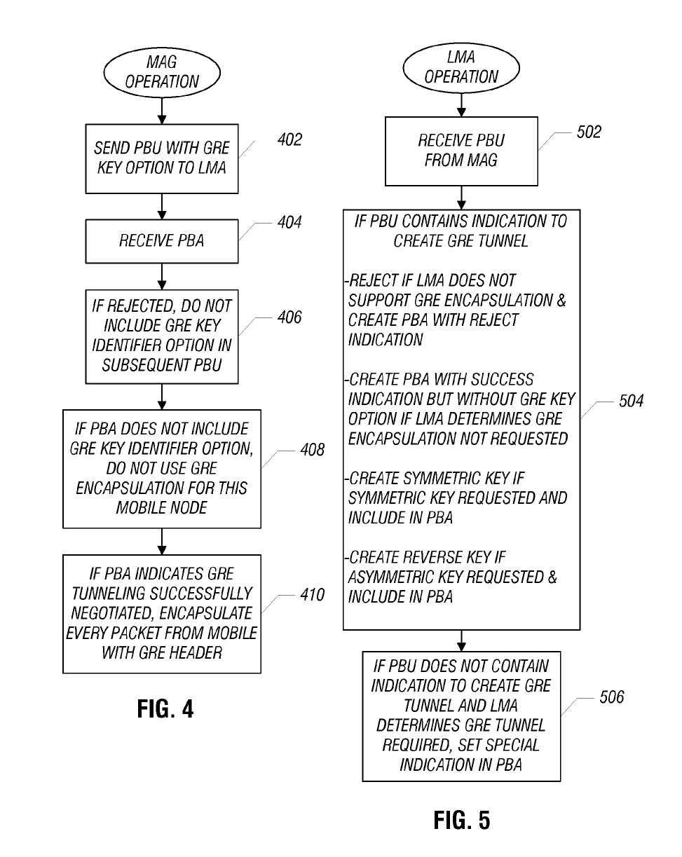

FIG. 4 illustrates tasks performed by the MAG 102 or 104 (FIG. 1) according to a preferred embodiment. Note that in the proxy Mobile IPv4 context, similar tasks can be performed by the PMA. In the Mobile IPv6 context, similar tasks can be performed by the mobile node 100.

If the MAG 102 desires to establish a GRE tunnel with the LMA 106, then the MAG 102 sends (at 402) a PBU to the LMA 106, where the PBU contains an indication that GRE tunneling is desired. For example, the PBU can contain a GRE flag that is set to the value “1,” and the PBU also contains a GRE key option as discussed above. Note that the GRE key option can include the Option Subtype field 206 (FIG. 2), which can contain value “01” (to indicate asymmetric key generation), or “11” (to indicate symmetric key generation). If the Option Subtype field 206 contains value “01,” then the PBU sent by the MAG would include a GRE key for the forward direction (forward GRE key) that is to be used by the LMA to encapsulate packets sent in the forward direction in the GRE tunnel from the LMA to the MAG for a target mobile station. Also, the Option Subtype field 206 in the PBU having the value “01” is an indication to the LMA that the LMA is to generate a GRE key for the reverse direction (reverse GRE key). This reverse GRE key would be sent by the LMA to the MAG, where the reverse key would be used by the MAG to encapsulate packets from the mobile node for communication through the GRE tunnel to the LMA. On the other hand, if the Option Subtype field 206 contained in the PBU has the value “11,” that is indication to the LMA that the LMA is to generate a symmetric key that is to be used for both the forward and reverse directions in the tunnel. The LMA would then communicate this symmetric key back to the MAG in a PBA message.

Alternatively, as will be explained further below, instead of using the GRE flag, an HNP option can be used instead to explicitly specify that GRE tunnel establishment is desirable. Also, as explained above, an implicit indication that GRE tunnel establishment is desirable can be accomplished by merely including the GRE key option 200 (without using a GRE flag or HNP option). Moreover, instead of using the Option Subtype field 206 to explicitly specify symmetric versus asymmetric key generation, an implicit mechanism can be used instead, where the key field contained in the GRE key option can be set to an invalid value to specify generation of a symmetric key, while a valid forward GRE key contained in the key field would indicate that asymmetric key generation is desirable.

The MAG next receives (at 404) a PBA message that is responsive to the PBU message. The content of the PBA message is set by the LMA depending upon various conditions. For example, the LMA can reject the MAG's request for GRE tunnel generation if the LMA is unable to support GRE tunneling. In this case, the PBA received contains an indication that the LMA has rejected establishment of a GRE tunnel between the MAG and LMA, and in response, the MAG sets (at 406) an indication that it is not to include a GRE key option in subsequent PBU messages. A rejection can be indicated by the GRE flag not being set in the PBA sent from the LMA to the MAG. Alternatively, the rejection can be indicated by including a special status code in the PBA message.

Alternatively, the PBA message sent by the LMA can have the GRE flag set, but the PBA message does not include a GRE key option. That is an indication to the MAG that GRE tunneling is not to be used for the mobile node since GRE encapsulation is not required for the mobile node. The MAG then sets (at 408) an indication to not use GRE tunneling for this mobile node.

In the cases that the MAG receives a PBA message that indicates GRE tunneling is not be used, the MAG can use a default IP-in-IP encapsulation tunneling technique.

If the PBA message contains an indication of successful GRE tunnel establishment (e.g., both GRE flag set and GRE key option contained in the PBA message), then the MAG will encapsulate (at 410) every packet from the mobile node with the GRE header containing the negotiated reverse GRE key or symmetric key for transmission in the GRE tunnel to the LMA.

FIG. 5 shows tasks performed by the LMA, according to a preferred embodiment. Note that in the proxy Mobile IPv4 context, similar tasks can be performed by the AGW. In the Mobile IPv6 context, similar tasks can be performed by the home agent.

The LMA receives (at 502) a PBU message from the MAG. If the PBU message contains an explicit indication (e.g., GRE flag set or HNP option set, and GRE key option included in the PBU message) or an implicit indication (e.g., GRE key option included) that GRE tunnel establishment is desirable, the LMA performs processing (at 504) according to various criteria. If the LMA does not support GRE tunneling, the LMA will reject the PBU message requesting GRE tunneling, and the LMA will create the PBA with the reject indication.

If the LMA determines that GRE tunneling is not required even though the LMA is able to support GRE tunneling, then the LMA will create a PBA message with a success indication, but without a GRE key option.

On the other hand, if the LMA determines that it is able to support GRE tunneling and that GRE tunneling is in fact required, then the LMA can create either a symmetric key or an asymmetric key based on the value of the Option Subtype field 206 (FIG. 2) contained in the PBU message, or alternatively, based on whether the GRE key field 208 contains a valid or invalid GRE key. A symmetric key is created by the LMA for use in both the forward and reverse directions if the MAG requests creation of a symmetric key. However, if the Option Subtype field 206 of the PBU message contains value “01,” or alternatively, the GRE key field 208 contains a valid forward GRE key value, then the LMA will store the forward GRE key contained in the PBU message for later use, and the LMA will also generate a reverse GRE key that is to be sent back to the MAG in a PBA message.

If the PBU message received from the MAG does not contain an indication (explicit or implicit) to create GRE tunnel, but the LMA determines that GRE tunneling is in fact required, then the LMA will set a special indication in the PBA message that is sent back to the MAG, which will cause the MAG to resend a PBU message with the GRE key option.

If successful establishment of a GRE tunnel is indicated in the PBA message sent from the LMA back to the MAG, then the LMA will encapsulate bearer data packets sent in the GRE tunnel to the MAG using either the symmetric key or forward GRE key negotiated as part of GRE tunnel establishment.

The establishment of GRE tunnels between mobility nodes in a network can be applied in a 3GPP2 (Third Generation Partnership Project 2) network, such as a 3GPP2 Ultra Mobile Broadband (UMB) network. UMB is designed to improve upon the CDMA2000 (Code Division Multiple Access 2000) standard for wireless communications. The UMB architecture is based upon Internet networking technologies running over a next generation (e.g., 4^{th} generation) wireless system.

In the UMB architecture, the MAG 102 or 104 in FIG. 1 is referred to as an evolved base station (eBS), and the LMA 106 in FIG. 2 is referred to as an access gateway (AGW). The GRE tunnel will be established between the eBS and AGW in the UMB network.

In other implementations, tunneling between mobility nodes can be established in other types of networks, either wireless or wired.

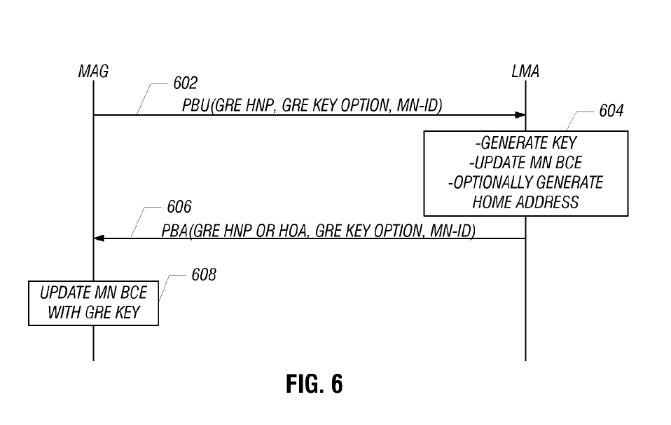

FIG. 6 shows exchanges of messaging between an MAG and an LMA in which a GRE HNP option, along with a GRE key option, is used to indicate that a GRE tunnel is to be established between the MAG and LMA. As depicted in FIG. 6, a PBU message is sent (at 602) from the MAG to the LMA.

The PBU message can include a GRE home network prefix (HNP) option, which can be set to a particular invalid value (e.g., all “1 s”) to indicate a request for establishment of a GRE tunnel and the dynamic creation of a GRE key or GRE keys. A home network prefix normally is used by a mobile node to construct an IP address of the mobile node. By providing an HNP option in a PBU message, an indication can be provided by the MAG that the LMA is to dynamically allocate an HNP, as well as to establish a GRE tunnel and create the corresponding GRE key.

In the FIG. 6 implementation, when the MAG sends a PBU message to the LMA, the PBU message can have an HNP option that is set to a particular invalid value, such as all 1s. This particular invalid value of the HNP option is to indicate that dynamic GRE key(s) is (are) to be created for the GRE tunnel, and also that a GRE HNP is to be dynamically allocated. Alternatively, the GRE HNP option contained in the PBU message can contain a valid home network prefix, which can be preconfigured at the MAG or received by the MAG during access authentication, for example.

In the PBU message, the MAG can set the GRE key field 208 (in FIG. 2) to a particular invalid value (such as all 0s) to indicate that the LMA is to allocate a symmetric GRE key (to be used for both the forward and reverse directions in the tunnel between the MAG and the LMA). Alternatively, if asymmetric GRE key generation is to be performed, the GRE key field will include a valid forward GRE key value, rather than all 0s or other invalid value.

Note that the PBU message sent at 602 also includes a mobile node identifier (MN-ID) or, alternatively, a network access identifier (NM). If the IP transport between the MAG and LMA is an IPv4 transport, then the MAG can set the IPv4 care-of address option to the MAG IPv4 address in the PBU message.

When the LMA receives a PBU that contains one of the various values mentioned above, the LMA creates (at 604) a binding cache entry that supports GRE tunneling for the mobile node based on the mobile node identifier (or network access identifier) contained in the PBU message. A binding cache entry can include the following fields: the home address of the mobile node; the care-of address for the mobile node; and other fields. In accordance with some preferred embodiments, the binding cache entry can also include the GRE key field created by the LMA and/or received from the MAG. The LMA also assigns a GRE home network prefix or home address (of the mobile node) to the binding.

The LMA also generates the GRE key (symmetric or asymmetric key) and associates the GRE key with the binding. The LMA includes the following entries in the PBA message sent (at 606) to the MAG: GRE HNP, the home address, GRE key option containing the symmetric or reverse GRE key, and MN-ID. When an MAG receives a successful PBA message, the MAG updates (at 608) the mobile node binding cache entry with the GRE HNP or home address and the LMA-created GRE key (symmetric key or reverse GRE key).

The LMA can also include a home address, such as an IPv4 home address option, in the PBA message, where the IPv4 home address option would include the home address of the mobile node. The IPv4 home address could be a private home address. When the MAG receives a successful PBA message containing the IPv4 home address address option, the MAG can update the mobile node binding with the home address.

Instructions of software described above (e.g., GRE control module 108 or 110) are executed on the processor. The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of communicating in a network that supports mobility of a mobile node, comprising:
establishing a tunnel between a first mobility node and a second mobility node in the network, wherein the established tunnel is according to a tunneling protocol that uses at least one key for encapsulating data communicated through the tunnel; and
communicating signaling to provide mobility support of the mobile node according to a mobility protocol, wherein the mobility protocol is selected from among a Proxy Mobile Internet Protocol (IP) and Mobile IP version 6 (IPv6).

2. The method of claim 1, wherein establishing the tunnel between the first mobility node and the second mobility node comprises establishing the tunnel between a mobile access gateway and a local mobility anchor, wherein the mobility protocol is Proxy Mobile IP.

3. The method of claim 2, wherein Proxy Mobile IP comprises one of Proxy Mobile IPv4 and Proxy Mobile IPv6.

4. The method of claim 1, wherein establishing the tunnel between the first mobility node and the second mobility node comprises establishing the tunnel between a first mobile access gateway and a second mobile access gateway during a handoff procedure.

5. The method of claim 1, wherein establishing the tunnel between the first mobility node and the second mobility node comprises establishing the tunnel between the mobile node and a home agent.

6. The method of claim 1, wherein establishing the tunnel between the first mobility node and the second mobility node comprises establishing a Generic Routing Encapsulation (GRE) tunnel.

7. The method of claim 1, wherein establishing the tunnel comprises:
sending a request message from the first mobility node to the second mobility node, wherein the request message contains an indication that creation of the tunnel is desired, wherein the request message comprises one of a proxy binding update (PBU) and proxy registration request (RRQ) message.

8. The method of claim 7, wherein sending the request message containing the indication comprises sending the request message containing an indication that the second mobility node is to create a key for use by the first mobility node to encapsulate data sent from the first mobility node to the second mobility node.

9. The method of claim 8, further comprising receiving, by the first mobility node, an acknowledge message responsive to the request message from the second mobility node, wherein the acknowledge message contains the key.

10. The method of claim 8, wherein sending the request message comprises sending the request message containing another key for use by the second mobility node to encapsulate data sent from the second mobility node to the first mobility node.

11. The method of claim 7, wherein sending the request message containing the indication comprises sending the request message containing an indication that the second mobility node is to create a symmetric key for use in encapsulating data in both directions in the tunnel between the first and second mobility nodes.

12. The method of claim 7, wherein sending the request message containing the indication comprises sending the request message containing the indication to create one of a symmetric key, an asymmetric key, and a uni-direction key.

13. The method of claim 7, wherein sending the request message containing the indication that creation of the tunnel is desired comprises sending the request message containing an implicit indication.

14. The method of claim 7, wherein sending the request message containing the indication that creation of the tunnel is desired comprises sending the request message containing an explicit indication.

15. The method of claim 7, wherein sending the request message comprises sending the request message containing a home network prefix option, wherein the indication is part of the home network prefix option.

16. The method of claim 15, wherein sending the request message containing the home network prefix option is an indication that dynamic creation of the home network prefix by the second mobility node is desired.

17. A first mobility node for use in a network that supports mobility of a mobile node, comprising:
an interface for communication with a second mobility node in the network; and
a processor to:
send a first message to the second mobility node, wherein the first message contains an indication that establishment of a Generic Routing Encapsulation (GRE) tunnel between the first and second mobility nodes is desired; and
communicate signaling with the second mobility node to provide mobility support of the mobile node according to a mobility protocol, wherein the mobility protocol is selected from among a Proxy Mobile Internet Protocol (IP) and Mobile IP version 6 (IPv6).

18. The first mobility node of claim 17, wherein the message comprises a proxy binding update (PBU) message.

19. The first mobility node of claim 17, wherein the processor is configured to further receive a second message responsive to the first message, wherein the second message contains a key to be used for encapsulating data communicated through the tunnel.

20. The first mobility node of claim 19, wherein the key contained in the second message is one of: (1) a symmetric key for encapsulating data in both a forward direction and reverse direction; and (2) a reverse key for encapsulating data in the reverse direction.

21. An article comprising at least one computer-readable storage medium containing instructions that when executed cause a first mobility node to:
send a first message to a second mobility node, wherein the first message contains an indication that establishment of a tunnel is desired, wherein the tunnel is according to a tunneling protocol that uses at least one key for encapsulating data communicated through the tunnel; and
communicate signaling with the second mobility node to provide mobility support of the mobile node according to a mobility protocol, wherein the mobility protocol is selected from among a Proxy Mobile Internet Protocol (IP) and Mobile IP version 6 (IPv6).

22. The article of claim 21, wherein the tunnel is a Generic Routing Encapsulation (GRE) tunnel.
